(19) United States
(12) Patent Application Publication
(10) Pub. No.: US 2014/0357112 A1
(43) Pub. Date: Dec. 4, 2014

(54) PLUG FIXING APPARATUS

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventor: XIAO-FENG MA, Shenzhen (CN)

(73) Assignees: HONG FU JIN PRECISION INDUSTRY (ShenZhen) CO., LTD., Shenzhen (TW); HON HAI PRECISION INDUSTRY CO., LTD., New Taipei (TW)

(21) Appl. No.: 14/287,686

(22) Filed: May 27, 2014

(30) Foreign Application Priority Data
May 30, 2013 (CN) 2013102079314

(51) Int. Cl. H01R 13/639

(52) U.S. Cl. CPC H01R 13/639
USPC 439/347

(57) ABSTRACT

A plug fixing apparatus for fixing a plug to a socket of an electronic device and includes a locking member slidably connected to the electronic device adjacent to the socket. The locking member includes a blocking portion. The blocking portion of the locking member is capable of engaging with the plug and preventing the plug from being pulled out of the socket.

### FIELD

The present disclosure relates to a plug fixing apparatus.

### BACKGROUND

In a server cabinet, a plug of a power cord is vulnerable to be pulled out of a socket of a power supply which will cause outage of the server and affect the function of the server.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an embodiment of a plug fixing apparatus.

FIG. 2 is similar to FIG. 1, but viewed from another perspective.

FIG. 3 is a partially assembled view of FIG. 1.

FIG. 4 is a cross-sectional view of FIG. 3, taken along the line IV-IV.

FIG. 5 is an assembled, isometric view of FIG. 1.

FIG. 6 is a cross-sectional view of FIG. 5, taken along the line VI-VI, showing the plug fixing apparatus in a locking state.

FIG. 7 is similar to FIG. 6, but showing the plug fixing apparatus in an unlocking state.

### DETAILED DESCRIPTION

The disclosure, including the accompanying drawing, is illustrated by way of examples and not by way of limitation. It should be noted that references to “an” or “one” embodiment in this disclosure are not necessarily to the same embodiment, and such references mean at least one.

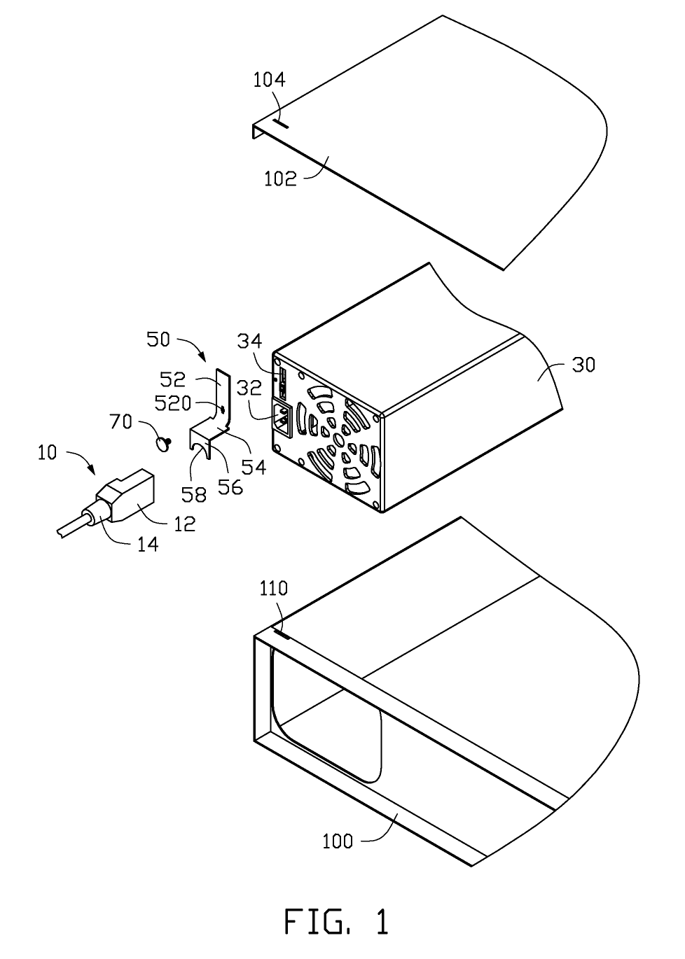

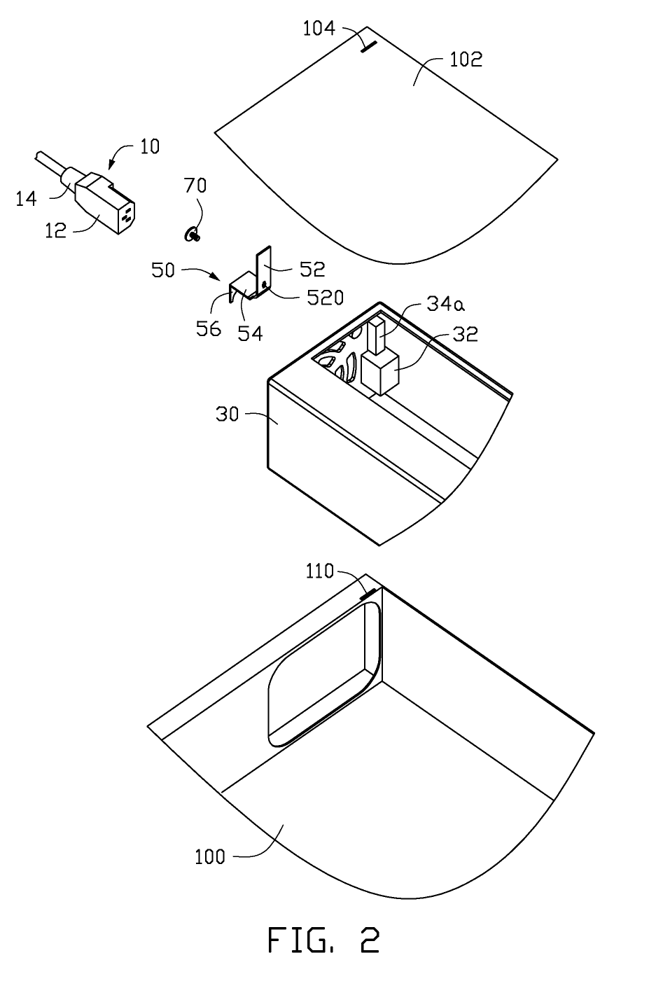

FIG. 1 and FIG. 2 illustrate an exemplary embodiment of a plug fixing apparatus for fixing a plug 12 of a power cord 10 to a socket 32 of a power supply 30. The plug fixing apparatus comprises a locking member 50 and a screw 70. The plug 12 comprises a connecting portion 14 at one side.

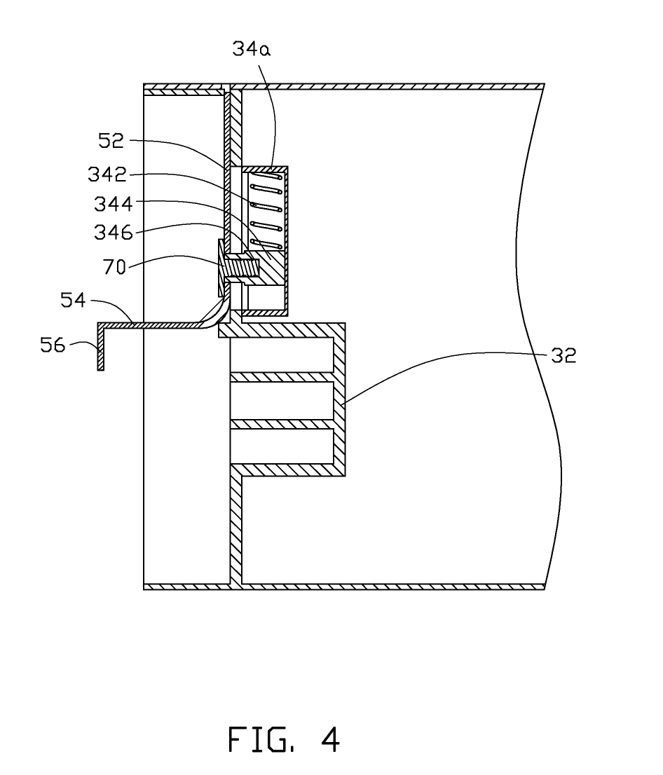

FIG. 1 and FIG. 4 illustrate that the power supply 30 defines a sliding slot 34 above the socket 32, and comprises a receiving portion 34a inside the power supply 30 bounding the sliding slot 34. The receiving portion 34a includes a spring 342 and a sliding member 344 which is connected to a distal end of the spring 342 and slidable up and down inside the receiving portion 34a. A screw hole 346 is defined in the sliding member 344.

The locking member 50 comprises a fixing piece 52, a supporting piece 54 vertically extending outward from a bottom of the fixing piece 52, and a blocking piece 56 vertically extending down from a distal of the supporting piece 54 and parallel to the fixing piece 52. The fixing piece 52 defines a fixing hole 520 adjacent to the supporting piece 54. A distal end of the blocking piece 56 away from the supporting piece 54 forms a blocking portion 58. The blocking portion 58 is an arc-shaped opening.

The power supply 30 is fixed in a chassis 100. The chassis 100 comprises a top board 102 covering the power supply 30. A folding piece extends from the top of the chassis 100. The folding piece defines a through hole 110. The top board 102 defines a through hole 104 aligning with the through hole 110. The chassis 100 defines an opening for allowing the power supply 30 to pass through.

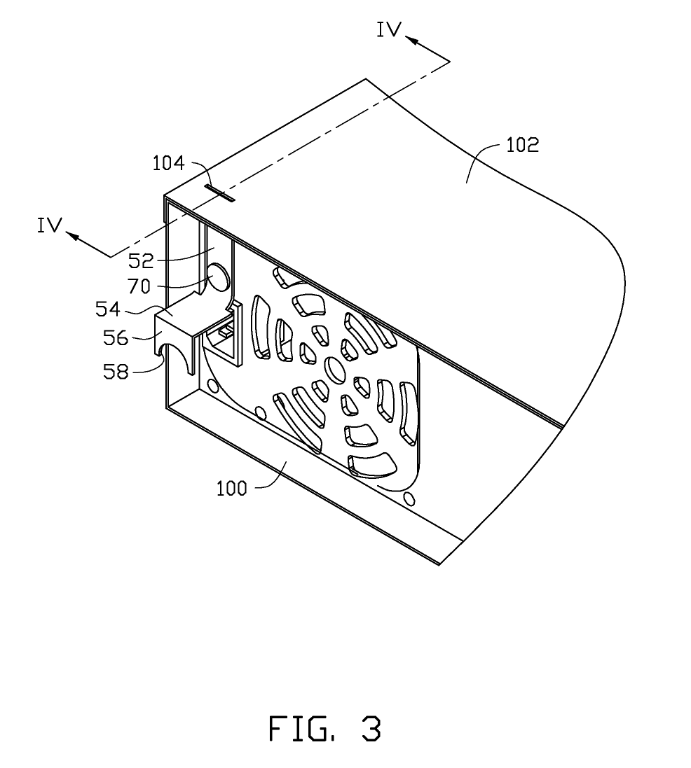

FIG. 3 and FIG. 4 illustrate that in assembly, a top of the fixing piece 52 is aligned with the through holes 110 and 104. The screw 70 extends through the fixing hole 520 and the sliding slot 34 and engages in the screw hole 346, to fasten the locking member 50 to the sliding member 344.

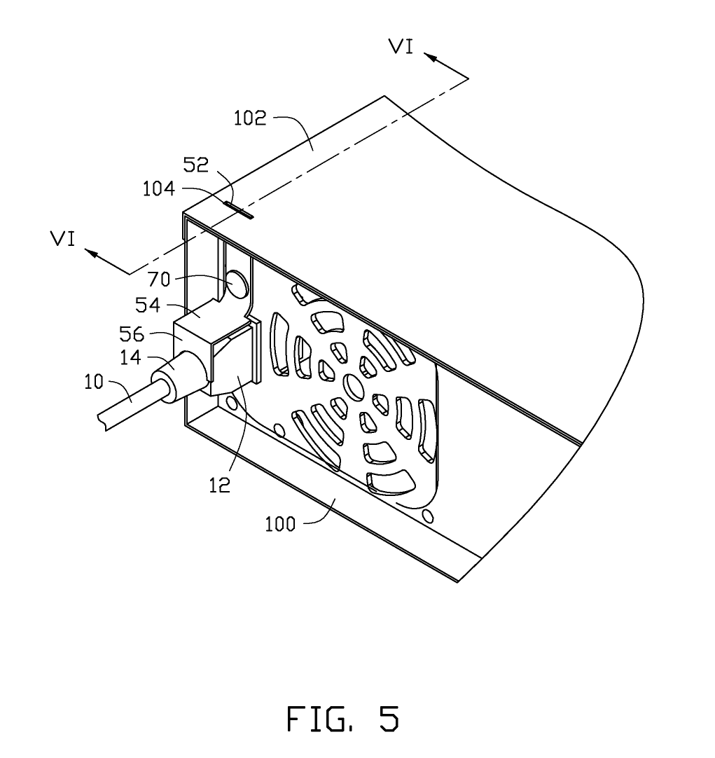

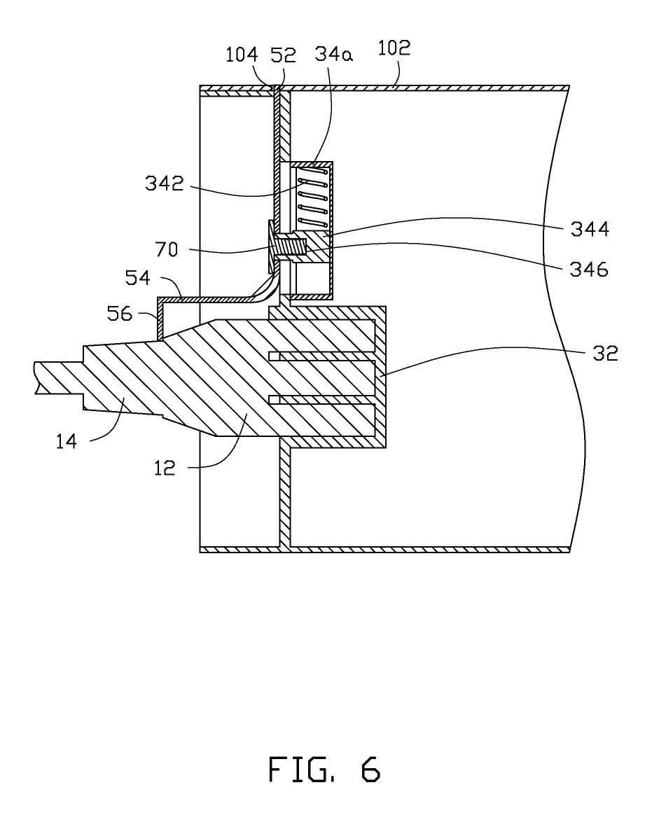

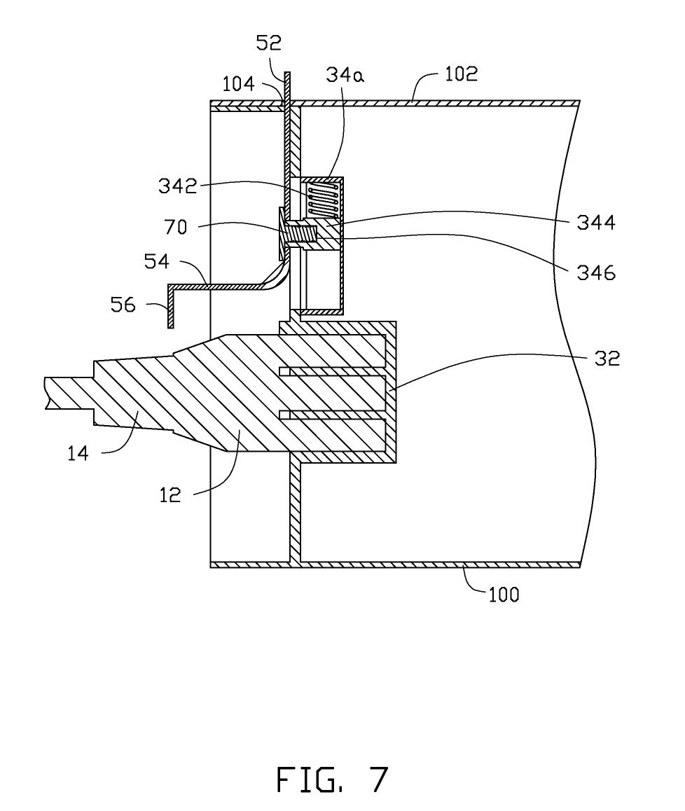

Referring to FIG. 5 through FIG. 7, upwardly push the locking member 50 to compress the spring 342, the top of the fixing piece 52 extends through the through holes 110 and 104. Insert the plug 12 of the power cord 10 into the socket 32 of the power supply 30, release the locking member 50, the locking member 50 slides down by the restoring force of the spring 342, and the connecting portion 14 of the power cord 10 is locked in the blocking portion 58 of the locking member 50, thereby the power cord 10 is fixed to the power supply 30. The blocking portion 58 engages with the connecting portion 14 of the power cord 10, and prevents the power cord 10 from loosening from the power supply 30.

To pull out the plug 12 from the socket 32, upwardly push the locking member 50, the top of the fixing piece 52 extends through the through holes 110 and 104 to make the locking member 50 disengage from the connecting portion 14. Thereby, the power cord 10 can be detached from the power supply 30.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A plug fixing apparatus for fixing a plug to a socket of an electronic device, the plug fixing apparatus comprising a locking member slidably connected to the electronic device adjacent to the socket, the locking member comprising a blocking portion, the blocking portion of the locking member capable of engaging with the plug and preventing the plug from being pulled out of the socket.

2. The plug fixing apparatus of claim 1, wherein the plug comprises a connecting portion at one side, and the blocking portion engages with the connection portion.

3. The plug fixing apparatus of claim 2, wherein the electronic device is a power supply, the electronic device defines a sliding slot adjacent to the socket and comprises a receiving portion bounding the sliding slot, inside the receiving portion is installed a spring and a sliding member connected to a distal end of the spring, the locking member is fixed to the sliding member.

4. The plug fixing apparatus of claim 3, wherein the locking member comprises a fixing piece, a supporting piece vertically extending outward from a bottom of the fixing piece, and a blocking piece vertically extending down from a distal end of the supporting piece and parallel to the fixing piece, the sliding member defines a screw hole, the fixing piece defines a fixing hole, a screw extends through the fixing hole and the sliding slot and engages in the screw hole, to fasten the locking member to the sliding member.

5. The plug fixing apparatus of claim 4, wherein the blocking portion is formed at a distal end of the blocking piece away from the supporting piece.

6. The plug fixing apparatus of claim 5, wherein the blocking portion is an arc-shaped opening.

7. The plug fixing apparatus of claim 4, wherein the power supply is fixed in a chassis, the chassis comprises a top board covering the power supply, each of the top board and the chassis defines a through hole for allowing a top of the fixing piece to pass through.
